(19) United States
(12) Patent Application Publication
(10) Pub. No.: US 2026/0108126 A1
(43) Pub. Date: Apr. 23, 2026

(54) CLEANING DEVICE FOR CONTROLLED ENVIRONMENTS

(71) Applicant: Carl Freudenberg KG, Weinheim (DE)

(72) Inventors: Jordon May, Fort Wayne, IN (US); Fred Cecala, Mount Prospect, IL (US); Leo Gubenko, Winfield, IL (US)

(73) Assignee: Carl Freudenberg KG, Weinheim (DE)

(21) Appl. No.: 18/919,115

(22) Filed: Oct. 17, 2024

(51) Int. Cl. A47L 13/42; A47L 13/16; A47L 13/256; B25G 1/06

(52) U.S. Cl. CPC A47L 13/42; A47L 13/16; A47L 13/256; B25G 1/06

(57) ABSTRACT

A cleaning device includes a hexagonal flat mop head and an articulating mop handle and that are geometrically configurable into a plurality of different cleaning positions with respect to linear handle axis to improve access to surfaces and corners of a restricted access controlled environment. To enable articulation of the mop handle, an articulating handle joint interconnects an upper handle segment and a lower handle segment so as to pivot with respect to a handle pivot axis that can be orthogonal to the linear handle axis. The cleaning device may also include a mop coupling enabling multiaxial movement of the flat mop head and the articulating mop handle.

### FIELD OF THE DISCLOSURE

The present disclosure relates to a cleaning device including a flat mop head and an articulating mop handle for cleaning controlled environments and RABS installations that are characterized by restricted accessibility.

### BACKGROUND

Controlled environments are used in industries such as semiconductor fabrication, pharmaceutical manufacturing, and precisions optics for the development and processing of substances and components. Controlled environments can maintain sterilized conditions or temperature and environmental control within an interior processing workspace which is physically isolated by one or more barriers that limit access to the processing space by workers. An example of a controlled environment used in such fields is a restricted access barrier system (“RABS”), which is an installation configured to reduce or limit interaction between a worker and a contained workspace. Barrier isolators are another type of controlled environment that is commonly used in the pharmaceutical industry for processing of sensitive drugs and solutions. Other examples include glove boxes, fume hoods, and other equipment that include structural barriers to restrict physical access to the workspace.

These controlled environments may require maintaining stringent cleanliness standards, including maintaining sterility and ensuring low particle contamination (i.e., keeping surfaces and the air debris free) in order to avoid compromising product quality. Indeed, many facilities utilizing controlled environments and RABS installations, particularly pharmaceutical manufacturing facilities, are required by industry standards or government regulations to maintain a high degree of sterility and cleanliness.

The foregoing can be problematic, however, because the same structural features that restrict access to the workspace also impede cleaning, especially with conventional cleaning tools. For example, the controlled environment or RABS installation may include corners and surfaces that are not readily accessible due to the structural barriers arranged about the workspace and that are otherwise inconveniently positioned for cleaning.

In addition, the cleaning procedures employed with some controlled environments and RABS installations may be regulated or standardized to ensure desired levels of sterilization and decontamination. For example, the quantity or share of cleaning solutions or disinfectant may be prescribed and there may exist prepared instructions on the cleaning technique to ensure all surfaces of the equipment, including hard to access corners and crevasses, are satisfactorily cleaned. In some instances, the cleaning tools may be configured with removable and disposable contact pads or brushes to reduce contamination due to reuse.

### SUMMARY

The disclosure provides, in an aspect, a cleaning device in the embodiment of a flat head mop that is selectively configurable into a variety of different cleaning positions. The cleaning device includes a flat mop head connected to a pole-like articulating mop handle. The articulating mop handle may be generally elongated and includes an upper handle segment and a lower handle segment that, when arranged collinearly with respect to each other, established a linear handle axis.

To improve accessibility to corners and crevasses, the flat mop head can have a hexagonal shape including laterally opposed triangular pointed corners. To access differently arranged surfaces, the articulating mop handle includes an articulating handle joint that enables the upper and lower handle segments to pivot with respect to the linear handle axis. The articulating handle joint, in particular, may allow the relative angular displacement of the upper and lower handle segments into a plurality of cleaning positions, including obtuse, right-angled, and acute cleaning positions.

In another aspect, the cleaning device may also include a multiaxial mop coupling connecting the flat mop head and the articulating mop handle. The mop coupling may include, for example, a swivel joint establishing a swivel axis and a frame joint that establishes a longitudinal frame axis that enables pivoting of the mop in various different directions with respect to the linear handle axis. The swivel axis and the longitudinal frame axis can be arranged orthogonal to each other to create the multiaxial pivotal directions for the flat mop head.

For example, hexagonally shaped flat mop head may have a longitudinal or oblong direction extending along and establishing a longitudinal frame axis that is orthogonal to the linear handle axis. The swivel axis can be arranged to pivot the longitudinal frame axis laterally with respect to the linear handle axis such that the two axes may be moved into different angular positions. The frame joint, in contrast, enables the flat mop head to rotate with respect to the longitudinal frame axis disposed through it such that orthogonality between the linear handle axis and the longitudinal frame axis is maintained.

The articulating mop handle and the multiaxial mop connector enable the cleaning device to assume a variety of different cleaning positions to advantageously access various surfaces and corners within a restricted access controlled environment. For example, the ability of the articulating mop handle to assume an obtuse cleaning position, a right angle cleaning position, and an acute cleaning position allows for wiping down all possible internal surfaces within a box-like restricted access controlled environment from outside. These and other possible features and advantageous will be apparent from the following detailed description and the accompanying drawings.

### BRIEF DESCRIPTION OF THE DRAWINGS

Subject matter of the present disclosure will be described in greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a perspective view of a cleaning device having a flat mop head and an articulating mop handle having a hinge joint allowing reconfiguration into a plurality of cleaning positions including in a straight or co-linear position as shown.

FIG. 2 is a view of the cleaning device with the handle joint configured to align the articulating mop handle in a right angled position as shown.

FIG. 3 is a view of the cleaning device with the handle joint configured to bend the articulating mop handle in an obtuse position of approximately 135°.

FIG. 4 is a view of the cleaning device with the handle joint configured to bend the articulating mop handle in an acute position of approximately 60°.

FIG. 5 is a view of the cleaning device with the handle joint configured to bend the articulating mop handle backwards upon itself for storage.

FIG. 6 is an assembly view of an embodiment of the articulating handle joint configured to releasably lock the articulating mop handle in the plurality of cleaning positions.

FIG. 7 is a perspective view of the telescoping handle segment and ergonomic hand grip that enables extension of the articulating mop handle.

FIG. 8 is a perspective view of a multiaxial mop coupling interconnecting the flat mop head to the articulating mop handle.

FIG. 9 is a cross-sectional view of the multiaxial mop coupling including a swivel joint and a frame joint for maneuvering the flat mop head into a variety of different positions.

FIG. 10 is a rear perspective view of the mop frame of flat mop head having a two-piece split frame-design and an oblong hexagonal shape for accessing corners.

FIG. 11 is a rear perspective view of the mop frame with the frame latch released and the split frame design displaced to discard or install a mop pad.

FIG. 12A is a perspective view of a microfiber mop pad having laterally opposed pad pockets to secure to the hexagonal shaped mop frame.

FIG. 12B is a detailed cross section of the microfiber mop pad as indicated in FIG. 12A illustrating multiple layers.

FIG. 13 illustrates use of the cleaning device configured in the right angle cleaning position to clean the inner surface of a controlled environment in accordance with the disclosure.

FIG. 14 illustrates use of the cleaning device configured in the obtuse cleaning position to clean the inner surface of a controlled environment in accordance with the disclosure.

FIG. 15 illustrates use of the cleaning device configured in the actuate cleaning position to clean the inner surface of a controlled environment in accordance with the disclosure.

### DETAILED DESCRIPTION

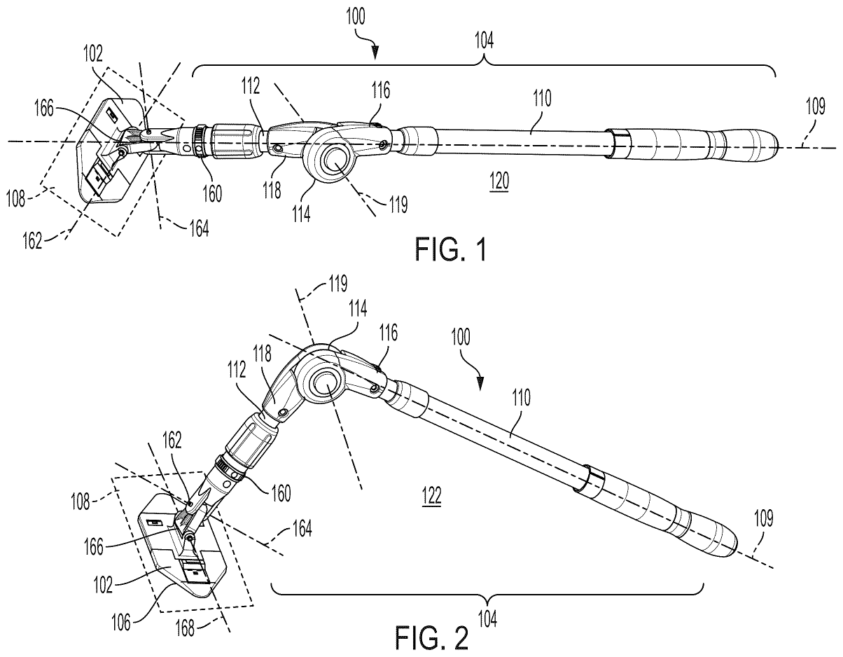

Now referring to the drawings, wherein whenever possible, like reference numbers refer to like elements, there is illustrated in FIGS. 1 and 2 a cleaning device 100 in the embodiment of a flat mop having a flat mop head 102 connected to an elongated mop handle 104. As common in the art, the flat mop head 102 can be fitted with a cleaning pad cover 106 made of cloth or a microfiber material that physically contacts the surface being cleaned.

The flat mop head 102 is further characterized by its flat, low profile relative to the elongated mop handle 104 that improves maneuverability and cleaning around and underneath objects and equipment. The flat profile of the mop head 102 establishes a two-dimensional mop plane 108 that corresponds to the geometry of the mop head 102 and that may typically be orthogonal to the mop handle 104. The mop plane 108 defines the plane of contact between the flat mop head 102 and the surface being cleaned during use.

The low, flat profile of the flat mop head 102 and the attachable cleaning pad cover 106 distinguishes conventional string mops comprised of individual matted fibrous strings bunched and connected to the end of a mop handle. As described in more detail below, the flat mop head 102 can be shaped as an oblong hexagon that is coplanar to the mop plane 108 to facilitate maneuvering while cleaning and the cleaning pad cover 106 may be configured as a removable cover and is specifically arranged to detachably fit to the hexagonal mop head 102.

The elongated mop handle 104 has a long pole-like configuration enabling the cleaning device to be grasped and manipulated by hand. The mop handle 104 can extend along and define a linear handle axis 109 at one axial end of which is attached the flat mop head 102. The mop handle 104 can be characterized as having a sufficiently small circumference or cross-section for grasping compared with an elongated axial length which increases the reach of the flat mop head 102. To improve the reach and functionality of the cleaning device 100, the mop handle 104 can be articulated, thus enabling it to fold or bend upon itself and with respect to the linear handle axis 109 into a variety of different positions for cleaning or storage.

To enable articulation of the cleaning device 100, in an embodiment, the articulating mop handle 104 can include an upper handle segment 110 and a lower handle segment 112 that are connected by an articulating hinge or pivot joint 114. For example, the upper handle segment 110 and the lower handle segment 112 can be commonly configured in a collinear arrangement with respect to the linear handle axis 109 and the articulating handle joint 114 can be disposed along the linear length defined by the articulating mop handle 104. The mid-length location of the articulating handle joint 114 results in configuring the upper and lower handle segments 110, 112 as a kinematic pair that can pivotally articulated with respect to each other between a collinear relation and various angular relations. The articulating handle joint 114 allows the flat mop head 102, which may be attached to the lower handle segment 112, to be angularly displaced or offset from the linear handle axis 109, which for reference may be delineated with respect to the upper handle segment 110.

To connect to the upper and lower handle segments 110, 112 of the articulating mop handle 104, the articulating handle joint 114 can include a first joint link 116 and a second joint link 118 that are operatively fixed together and that can angularly pivot with respect to each other about a handle pivot axis 119. The articulating handle joint 114 thus provides a single degree of rotation with respect to the handle pivot axis 119. The first and second joint links 116, 118 can be made of rigid material such as molded plastic and operatively intersect each other at the handle pivot axis 119.

The first joint link 116 and the second joint link 118 can be connected to the upper and lower handle segments 110, 112 such that the handle pivot axis 119 is perpendicular to and may intersect the linear handle axis 109. The handle pivot axis 119 is therefore also perpendicular to the lengthwise extension of the articulating mop handle 104 and can be oriented in a lateral side-to-side extension with respect to the mop handle 104.

Enabling articulation of the flat mop head 102 with respect to the linear handle axis 109 enables the cleaning device 100 to advantageously interact with the cleaning surfaces that may have various different orientations, especially in controlled environments and RABS installations. For example, in a standard collinear or straight position 120 or arrangement, depicted in FIG. 1, the upper handle segment 110 and the lower handle segment 112 can be collinearly aligned along the linear handle axis 109 so that the articulating mop handle 104 is straight. The collinear cleaning position 120 can be characterized as having 180° angular arrangement between the upper and lower handle segments 110, 112. The collinear cleaning position 120 of the articulating mop handle 104 enables the flat mop head 102 to be pressed into contact with a cleaning surface that may be oriented generally normal to the linear handle axis 109.

To reach and access cleaning surfaces that may be oriented differently with respect to the linear handle axis 109 of the articulating mop handle 104, for example, surfaces that are substantially parallel to the linear handle axis 109, the articulating handle joint 114 can enable the upper and a lower handle segments 110, 112 to pivot approximately 90° with respect to each other about the handle pivot axis 119 as depicted in FIG. 2. The right angled position 122 or normal position shown in FIG. 2 allows the flat mop head 102 to be pressed downwardly against a surface that is oriented parallel to the upper handle segment 110 while enabling the flat mop head 102 to be moved back and forth in a wiping action by moving the upper handle segment 110 along the linear handle axis 109 in an analogous manner.

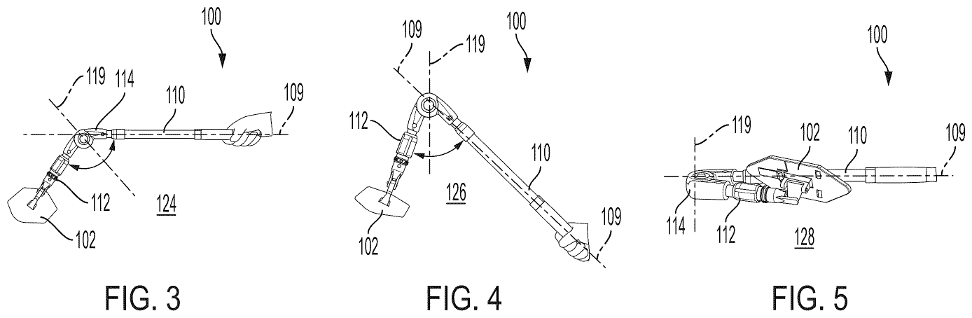

The articulating handle joint 114 can pivot the articulating mop handle 104 into various other positions and configurations to improve cleaning by enabling the flat mop head 102 to reach surfaces located at unusual orientations or encumbered by access restrictions. For example, referring to FIG. 3, the cleaning device 100 is illustrated in an obtuse cleaning position 124 in which the lower handle segment 112 is angularly offset with respect to the upper handle segment 110 and the linear handle axis 109 at an obtuse angle. In the obtuse cleaning position 124, the flat mop head 102 is still forwardly directed with respect to the linear handle axis 109 but is offset to contact surfaces that may be orientated parallel or nearly parallel with the linear handle axis 109. The obtuse cleaning position 124 can include any practicable obtuse angle between the upper handle segment 110 and the lower handle segment 112 including, for example, a 135° angle.

Referring to FIG. 4, the cleaning device 100 is illustrated in an acute cleaning position in which the lower handle segment 112 is angularly oriented at an acute angle with respect to the upper handle segment 110 and the linear handle axis 109. In the acute cleaning position 126, the lower handle segment 112 is partially inverted backwards with respect to the upper handle segment 112. The acute cleaning angle 126 reverses and inverts the flat mop head 102 backwards with respect to the linear handle axis 109 allowing the flat mop head 102 to access obstructed surfaces as described below. The acute cleaning position 126 can include any suitable acute angle between the upper handle segment 110 and the lower handle segment 112 including, for example, a 60° angle.

In an embodiment depicted in FIG. 5, the articulating handle joint 114 can form an acute angle in which the upper and lower handle segments 110, 112 are almost parallel and arranged in a side-by-side relation. In the inverted position 128, the linear length of the articulating mop handle 104 is reduced with respect to the linear handle axis 109. The inverted angle 128, in which the upper and lower handle segments 110, 112 are approximately side-by-side, can be useful in storing the cleaning device 100 when not in use.

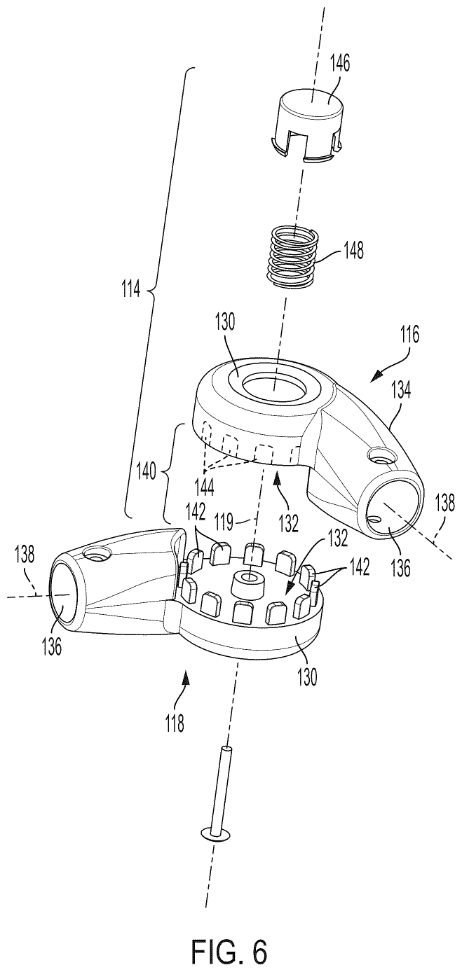

In an embodiment, to enable the articulating handle joint 114 to pivot the upper and lower handle segments 110, 112 about the handle pivot axis 119 to the different cleaning positions as shown, the first and second joint links 116, 118 can be structurally configured as depicted in FIG. 6. For example, the first and second joint links 116, 118 can be generally identical in structure and can be made from molded plastic. The first and second joint links 116, 118 can each include a knuckle end 130 which defines a planar abutment face 132 and a socket end 134 into which is disposed a socket bore 136. The knuckle ends 130 of the first and second joint links 116, 118 can be generally rounded such that the planar abutment faces 132 are circular and of comparable diameters.

To connect with the respective upper and lower handle segments 110, 112, the socket bores 136 of the socket ends 134 can be cylindrical bores dimensioned to receive correspondingly shaped pole components of the respective handle segments. The socket bores 136 can define and extend along a socket axis 138 that aligns with the direction of insertion of the first and second handle segments 110, 112 into the respective socket end 134. The socket axes 138 can be orthogonal to and can intersect with the laterally oriented handle pivot axis 119. The socket axes 138 of the respective first and second joint links 116, 118 can also move into various angular offsets with respect to each other when the articulating handle joint 114 is pivoted.

In an embodiment, the socket bores 136 of the first and second joint links 116, 118 readily enables modular reconfiguration of the cleaning device 100. For example, different configurations of the upper handle segments 110 and lower handle segments can be easily removed and reattached to the articulating handle joint 114 using the socket ends 134 so that the length and/or shape of the articulating mop handle 104 can be selective altered depending upon its intended use. The connectivity enabled by the socket bores 136 formed as part of the first and second joint links 116, 118 facilitated interchangeability with different designs of the upper and lower handle segments 110, 112. The modularity of the articulating mop handle 104 provided by the socket ends 134 increase the versatility of the cleaning device 100 with respect to cleaning restricted access controlled environments.

When the articulating handle joint 114 is arranged for assembly, the planar abutment faces 132 are oriented parallel and opposite to each other and are perpendicular to the handle pivot axis 119. The planar abutment faces 132 are placed into abutting contact and can rotatably turn with respect to each other when the knuckle ends 130 of the first and second rigid joint links 116, 118 are adjacent each other and pivoted about the handle pivot axis 119.

To rigidly secure and lock the first and second rigid joint links 116, 118 at particular angular relations, for example, corresponding to the different cleaning positions shown, the articulating handle joint 114 can include a locking mechanism 140. For example, the locking mechanism 140 can be capable of rigidly locking the upper and lower handle segments 110, 112 into fixed angular arrangements when engaged and can be selectively released to allow the first and second handle segments to pivotally articulate about the handle pivot axis 119 to move between the various different cleaning positions.

In an embodiment, the locking mechanism 140 can include a plurality of detent pins 142 that project from the planar abutment face 132 of one knuckle end 130 that can be received into a corresponding plurality of locking apertures 144 disposed into the planar abutment face 132 of the second knuckle end 130. In an embodiment, the plurality of detent pins 142 and the plurality of locking apertures 144 can be arranged in a circle circumferentially extending around the handle pivot axis 119 that is perpendicular to the planar abutment faces 132. When the planar abutment faces 132 are placed adjacent to each other, the plurality of circularly arranged detent pins 142 are received into the corresponding plurality of locking apertures 144. The locking mechanism 140 is thus engaged and the physical placement of the plurality of detent pins 142 into the plurality of locking apertures 144 prevents relative rotation or pivotal movement of the first and second joint links 116, 118 with respect to the handle pivot axis 119.

To disengage the locking mechanism 140, for example, to angularly articulate the first and second joint links 116, 118 relative to each other and to the handle pivot axis 119, the locking mechanism 140 can include a depressible release button 146. The release button 146 can be a molded plastic component, and can be operatively associated with a coil spring 148 so that the release button 146 may be pressed and released by spring actuation. The release button 146 and the coil spring 148 can be operatively accommodated in the knuckle end 130 of the first join link 116 and can be aligned with the handle pivot axis 119.

The release button 146 and the coil spring 148 are operatively arranged so that when the release button 146 is depressed, the knuckle ends 130 of the first and second joint links 116, 118 separate apart from each other with respect to the handle pivot axis 119. Physical separation in the direction of the handle pivot axis 119 displaces the planar abutment faces 132 of the knuckle ends 130 and removes the plurality of detent pins 142 from the corresponding plurality of locking apertures 144. The first joint link 116 is therefore free to pivot with respect to the second joint link 118 by relative articulation about the handle pivot axis 119. When the release button 146 is released, the coil spring 148 can cause the planar abutment faces 132 of the first and second joint links 116, 118to move adjacently against each other such that the plurality of detent pins 142 are again received in the plurality of locking apertures 144. The locking mechanism 140 is reengaged and the articulating handle joint 114 is unable to articulate with respect to the handle pivot axis 119.

In an embodiment, the plurality of detent pins 142 and corresponding locking apertures 144 can be arranged to pivotally rotate the articulating handle joint 114 into a plurality of discrete angular increments about the handle pivot axis 119. The incremental angular movements can correspond to the plurality of cleaning positions 120-126. When the locking mechanism 140 is pivoted to the selected angular arrangement and the detent pins 142 are received in the locking apertures 144, the upper and lower handle segments 110, 112 are rigidly interlocked into the selected cleaning position and stiffens the articulating mop handle 104 such that applied forces can be transferred through the articulating handle joint 114 for example, to move the flat mop head 102 in a scrubbing action.

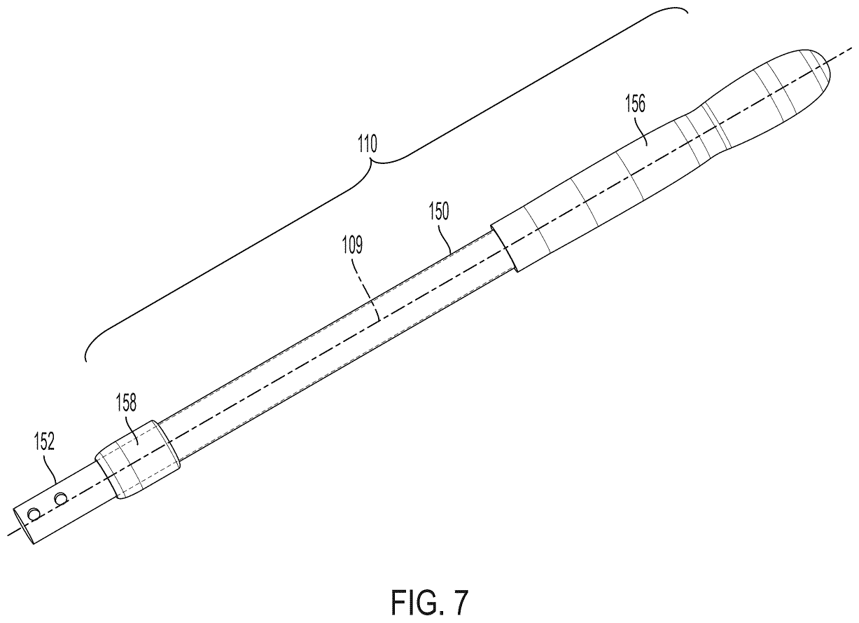

In an embodiment, to increase or shorten the length of the articulating mop handle 104, the upper handle segment 110 can be configured as a telescoping handle segment. For example, referring to FIG. 7, the upper handle segment 110 can include a tubular guide sleeve 150 and a telescopic shaft 152 that can be slidingly received therein. The tubular guide sleeve 150 and the telescopic shaft 152 can have complementary diameters to enable relative sliding motion. When assembled, the tubular guide sleeve 150 and the telescopic shaft 152 can be co-axially aligned along the linear handle axis 109 with the telescopic shaft 152 concentrically received in the tubular guide sleeve 150.

To allow the tubular guide sleeve 150 and the telescopic shaft 152 to linearly slide with respect to each other, the upper handle segment 110 can include a slip collar 154 located at an axial end of the tubular guide sleeve 150. The slip collar 154 can have an internal diameter operatively configured to radially compress about or expand apart from the telescoping shaft 152. When the slip collar 154 is twisted with respect to the linear handle axis 109, the internal diameter restricts or expands accordingly in order to arrest or release linear movement of the telescoping shaft 152 with respect to the tubular guide sleeve 150. The slip collar 154 thus provides a twist lock mechanism allowing selective extension of the upper handle segment 110 and adjustment of the overall length of the articulating mop handle 104.

To grasp the articulating mop handle 104 during use, the upper handle segment 104 can include an ergonomic hand grip 156 attached at an axial end opposite the slip collar 154. The ergonomic hand grip 156 can be disposed over the tubular sleeve guide 150 concentrically aligned with the linear handle axis 109 and can axially extend partially along the linear length of the upper handle segment 104. The ergonomic hand grip 156 can be made of a soft material such as a compressible rubber or foamed elastomer and can be shaped or contoured along the axial length to be comfortably grasped by hand.

Referring back to FIGS. 1 and 2, to enable the flat mop head 102 to assume different orientations and angular arrangements with respect to the articulating mop handle 104, the cleaning device 100 can include a multiaxial mop coupling 160. The mop coupling 160 can physical interconnect the flat mop head 102 and the articulating mop handle 104 while enabling multiaxial movement of the structural components relative to one another.

For example, the mop coupling 160 can include a swivel joint 162 that establishes a swivel axis 164 that enables the mop plane 108 of the flat mop head 102 to pivotally swivel to different angular inclines with respect to the lower handle segment 112 and, when collinear with the upper handle segment 110, to the linear handle axis 109. For example, the mop plane 108 can be moved from a position wherein it is orthogonal to the linear handle axis 109 to a position wherein the mop plane 108 is substantially parallel and in a side-by-side relation the linear handle axis 109. When the upper and lower handle segments 110, 112 are collinear, the swivel axis 164 may be orthogonal to the linear handle axis 109 of the articulating mop handle 104.

The mop coupling 160 can also include a frame joint 166 that establishes a longitudinal frame axis 168 that enables the flat mop head 102 to pivotally tilt with respect to the mop coupling. The longitudinal frame axis 168 can be aligned with the oblong hexagonal shape of the flat mop head 102 and can be parallel to the mop plane 108. The frame joint 166 allows the mop plane 108 to tilt or rotate with respect to the longitudinal frame axis 168 from a position orthogonal to the linear handle axis 109 to a position generally parallel to the linear handle axis 109. The frame joint 166 can physical connect the flat mop head 102 with the articulated mop handle 104.

The longitudinal frame axis 168 can be orthogonal to the swivel axis 164 and, when the upper and lower handle segments 110, 112 are collinear, can also be orthogonal to the linear handle axis 109. Moreover, the longitudinal frame axis 168 can be parallel with linear handle axis 119 when the articulating mop handle 104 is straight and the upper and lower handle segments 110, 112 are collinear. Accordingly, pivotal articulation of the articulating handle joint 114 causes the flat mop head 102 to revolve about the pivotal handle axis 119 while tilting of the frame joint 166 rotates the flat mop head 102 about the longitudinal frame axis 168.

For reference purposes, pivoting of the flat mop head 102 and the mop plane 108 about the swivel axis 164 to the lateral sides with respect to the articulating mop handle 104 and linear handle axis 109 may be referred to as swiveling. Likewise, pivoting the flat mop head 102 and the mop plane 108 about the longitudinal frame axis 168 to tilt upwardly with respect to the articulating mop handle 104 and linear handle axis 109 may be referred to as tilting.

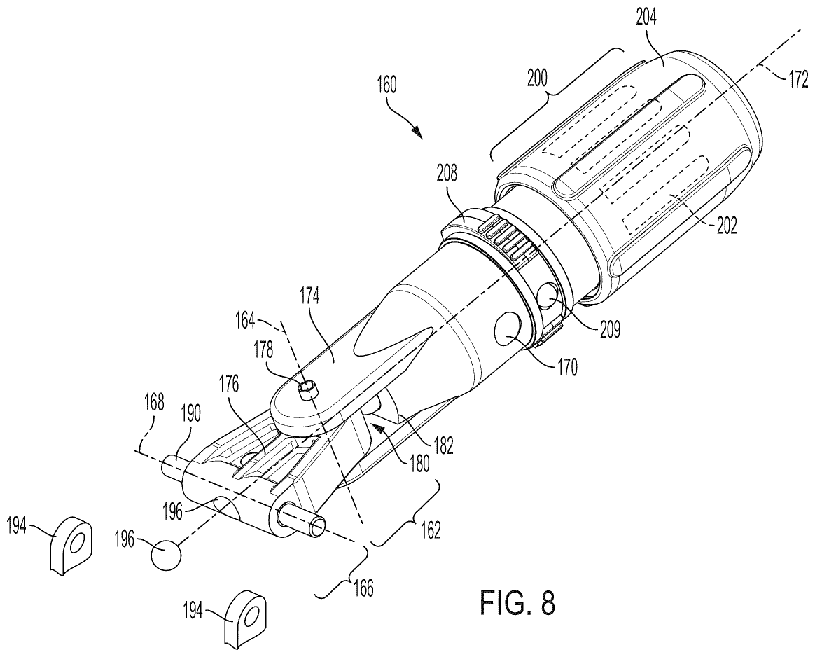

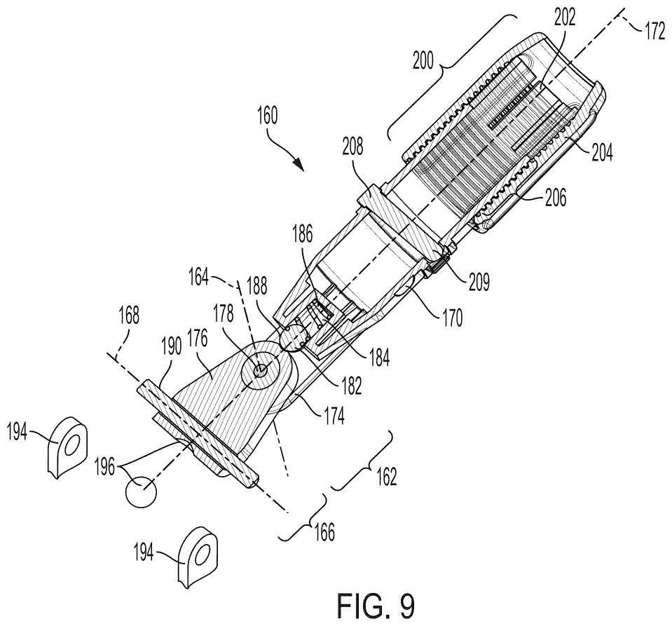

To geometrically arrange the swivel axis 164 and the longitudinal frame axis 168 with respect to each other, the mop coupling 160 can be an assembly of components an embodiment of which is depicted in FIGS. 8 and 9. For example, the mop coupling 160 can include a coupling barrel 170 that can be cylindrically shaped and can extend with respect to the coupling axis 172. The cylindrically shaped coupling barrel 170 may be hollow and can be formed from molded plastic for rigidity. The cylindrical coupling barrel 170 can be tapered at one axial end and which is formed as a bifurcated fork 174 with the bifurcations extending parallel to the coupling axis 172.

The bifurcated fork 174 may function as a structural part of the swivel joint 162 that can pivotally connect with a frame link 176 comprising the corresponding structural part of the swivel joint. The frame link 176 can be generally flat and triangular in shape. The apex of the flat, triangular frame link 176 can be inserted between the bifurcated fork 174 and the two parts can be joined by a swivel pin 178 inserted through the bifurcated forks and the apex to form a pivot joint that correspond to the swivel joint 162. When assembled, the swivel pin 178 corresponds to the swivel axis 164 and is orthogonal to the coupling axis 172 of the coupling barrel 170.

In an embodiment, to secure the swivel joint 162 in a preferred angular position and limit further articulation between the coupling barrel 170 and the frame link 176, the swivel joint 164 can include a ball detent limiter 180. Referring to FIG. 9, the ball detent limiter comprises a spherical ball 182, possibly made of steel, that is sized to be received in a ball bore 184 axial disposed into the coupling barrel 170 and aligned with the coupling axis 172. The ball bore 184 can be located between the forked structure of the bifurcated fork 174. The ball detent limiter 180 can also include a coil spring 186 located in the ball bore 184 that urges the spherical ball 182 linearly outward along the coupling axis 172.

When the swivel joint 162 is assembled, the spherical ball 182 is therefore urged against the apex of the frame link 176 that is oriented toward the ball bore 184. Formed into the apex of the frame link 176 can be a semispherical ball seat 188 which can accommodate a portion of the spherical ball 182. The spatial coincidence of the spherical ball 182 and the ball seat 188 prevent relative pivotal movement of the coupling barrel 170 and the frame link 176 locking the angular configuration of the swivel joint 162.

To disengage the ball detent limiter 180, force can be applied to frame link 176 to dislodge the spherical ball 182 from the ball seat 188 by compression of the coil spring 186. When the ball detent limiter 180 is engaged, the swivel joint 164 can be arranged such that the longitudinal frame axis 168 can be orthogonally transverse to the swivel axis 164 and axially offset and spaced apart from the swivel axis 164 with respect to the coupling axis 172.

To enable pivotal articulation about the longitudinal frame axis 168, the frame joint 166 can also be configured as a pin joint. For example, the base of the triangular fame link 176, opposite the apex located between the bifurcated fork 174, can include a longitudinal bore disposed therein which can accommodate a cylindrical frame pin 190. The frame pin 190 is thus aligned with the longitudinal frame axis 168 and can protrude from the longitudinal vertices of the triangular fame link 176.

The protruding ends of the frame pin 190 can rotationally connect with a corresponding journal or knuckle structure 194 on the flat mop head 102 allowing the flat mop head 102 and the frame link 176 to pivotally articulate with respect to each other about the longitudinal frame axis 168. In an embodiment, the frame joint 166 can also include a ball detent limiter 196, including a spherical ball urged by a coil spring into a corresponding semispherical ball seat, to provisionally fix or limit rotation of the frame joint 166 in preferred angular arrangements.

To connect the mop coupling 160 with the mop handle 102, a handle connector 200 can be disposed on the end of the coupling barrel 170 axially opposite of the bifurcated fork 174. The handle connector 200 can include a coupling collet 202 in the embodiment of a segmented tubular sleeve formed into the end of the coupling barrel 170. The coupling collet 202 is generally cylindrical and aligned with respect to the coupling axis 172.

The coupling collet 202 is operatively associated with a collet nut 204 that also has a sleeve-like physical configuration and is sized to concentrically extend over the axial end of the coupling barrel 170. The external diameter of the coupling barrel 170 and the internal diameter of the collet nut 204 may be threaded and may create a screw joint 206 such that relative rotation of the components causes the collet nut 204 to linearly move along the coupling axis 172.

The internal diameter of the coupling nut 204 may be tapered or truncated at one end such that when the segmented portion of the coupling collet 202 and the tapered portion of the coupling nut 204 are axially aligned, the segments are pressed radially inward, forcibly reducing the dimeter of the coupling collet 202. The coupling collet 202 can radially compress about a pole or shaft of a complementary diameter extending from the lower handle segment to secure the components together.

In an embodiment, the mop coupling 160 can also include a connection clip 208 that circumferentially extends about and clips to the coupling barrel 170. The connection clip 208 can include a projecting prong 209 that can be received in an aperture disposed transversely through the coupling barrel 170 and that may traverse and interlock with a component of the articulating mop handle inserted therein.

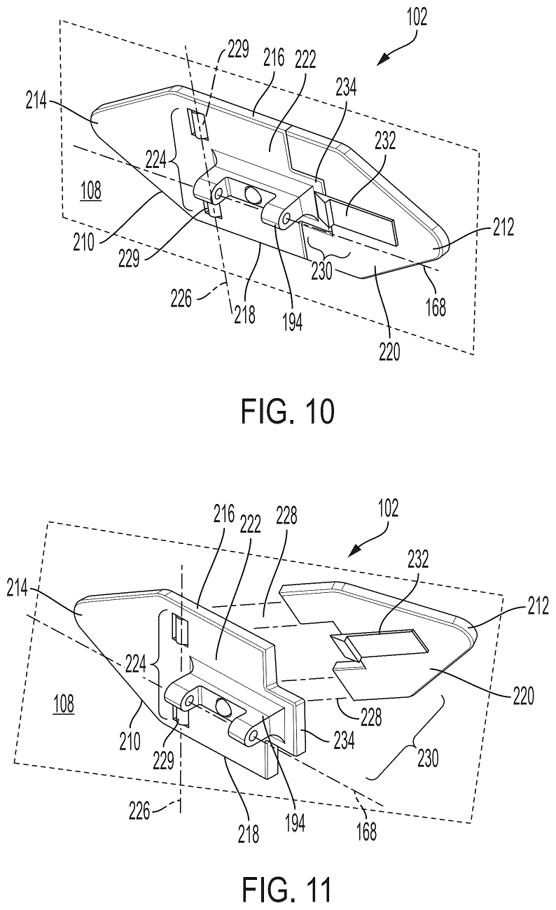

Referring to FIGS. 10 and 11, as mentioned above, to facilitate access to corners and crevasses within the controlled environments, the flat mop head 102 can be embodied or shaped as an oblong hexagon. For example, the flat mop head 102 can include a planar frame plate 210 that is generally flat and coextensively situated within the mop plane 108. The frame knuckle structure 194 that connects with the mop coupling may be formed on a planar exterior surface of the frame plate 210 such that the longitudinal frame axis 168 is aligned in extension with the oblong hexagonal shape of the flat mop head 102.

The outline of the frame plate 210 is hexagonal and can include a triangular first pointed tip 212 and an oppositely located triangular second pointed tip 214. The apexes of the triangular pointed tips 212, 214 are oppositely directed with respect to the longitudinal frame axis 168 and the vertices of the pointed tips can be bisected by the longitudinal frame axis 168. The angular dimensions of the triangular pointed tips 212, 214 can be selected to access the corners formed at the intersections of different surfaces of the controlled environments. To longitudinally offset the first and second pointed tips 212, 214, the frame plate 210 can also include a first longitudinal edge 216 and a second longitudinal edge 218 extending between the pointed tips and that are parallel to each other and to the longitudinal frame axis 168.

To facilitate fitting or discarding a mop pad cover, in an embodiment, the flat mop head 102 can have a split-frame design. For example, the frame plate 210 can be assembled from a first lateral wing 220 and a second lateral wing 222. The first and second lateral wings 220, 222 can be situated at longitudinally opposite sides of the frame plate 210 with respect to the longitudinal frame axis 168. The first lateral wing 220 can structurally correspond with the first triangular pointed tip 212 and the second lateral wing 222 can structurally correspond with the second triangular pointed tip 214.

The first and second lateral wings 220, 222 are pivotally connected to one another and can pivot with respect to each other. For example, the first and second lateral wings 220, 222 can cooperatively form a frame hinge 224 enabling pivotal articulation of the structures. The frame hinge 224 may also establish a frame hinge axis 226 that is orthogonally traverse to the longitudinal frame axis 168 and that respectively splits the planar frame plate 210 into the first and second lateral wings 220, 222.

In an embodiment, the first lateral wing 220 may include one or more hinge arms 228 that extend therefrom and that include hooks that may catch to correspondingly shaped pivot rods 229 disposed on the second lateral wing 222. The pivot rods 229 correspond to the frame hinge axis 226 and the hooks on the hinge arms 228 can slidingly rotate about the pivot rods 229 enabling the first and second lateral wings 220, 22 to pivotally articulate about the frame hinge axis 226. The frame hinge 224 enables the planar frame plate 210 to pivot between a set position shown in FIG. 10 in which the first and second lateral wings 220, 222 are co-planar with the mop plane 108 and a released position shown in FIG. 11 in which the first and second lateral wings 220, 222 are angularly displaced with respect to the mop plane 108.

To fix or release the frame plate 210 with respect to the set position, the frame hinge 224 can be operatively associated with a latch and catch mechanism 230. For example, the latch and catch mechanism 230 can include a spring-loaded sliding latch 232 that is mounted to the upper planar surface of the first lateral wing 220. The sliding latch 232 can be longitudinally movable with respect to the longitudinal frame axis 168 and may be located between the hinge arms 228 extending from the first lateral wing 220.

The catch 234 can be structurally formed on the second lateral wing 222 and can comprise a rectangular tongue or block longitudinally protruding with respect to the longitudinal frame axis 168 and similarly located between hinge arms 228. When the spring loaded sliding latch 232 is released, it may longitudinally extend over and physically slide against the upper planar surface of the catch 234 on the second lateral wing 222. The frame hinge 224 is prevented from articulating by relative pivoting of the first and second lateral wings 220, 222 which are geometrically maintained co-planar to each other within the mop plane 108 as illustrated in FIG. 10.

If the sliding latch 232 is forcibly moved in the opposite longitudinal direction with respect to the longitudinal frame axis 168, the sliding latch 232 releases the catch 234 and the first and second lateral wings 220, 222 can pivot with respect to each other and become displaced with respect to the mop plane 108 as illustrated in FIG. 11. When the latch and catch mechanism 230 is released and the frame hinge 224 pivots the first and second lateral wings 220, 222 together about the frame hinge axis 226, the first and second triangular pointed tips 212, 214 spatially coverage together. Angular convergence of the first and second pointed tips 212, 214 effectively reduces the longitudinal length of the flat mop head in the longitudinal frame axis 168.

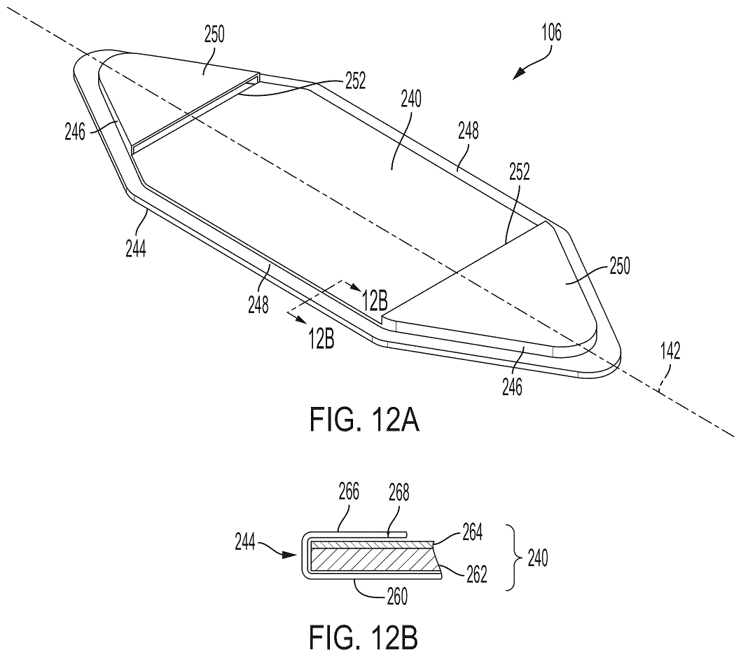

Referring to FIG. 12A, there is illustrated an embodiment of the cleaning pad cover 106 configured to fit over the planar frame plate 210 of the flat mop head 102 for cleaning the surfaces of the controlled environment by direct physical contact. In the embodiments in which the flat mop head 102 is hexagonal in shape to improve accessibility to corners and crevasses, the cleaning pad cover 106 can have a corresponding hexagonal shape; although in other embodiments, other shapes are contemplated. The cleaning pad cover 106 can be made of a pliable absorbent material as described below and can be relatively soft to avoid damaging or scratching the surfaces being cleaned. The cleaning pad cover 106 can be made from natural or synthetic fabrics and textiles arranged and processed to fit firmly and securely about the planar frame plate 210.

In present embodiment, the cleaning pad cover 106 can included a planar main sheet 240 that is oblong in shape and that may be oriented about a lateral pad centerline 242. The main sheet 240 of the cleaning pad cover 106 is flat and can be placed adjacently against the frame plate 210 to be moved over a surface during cleaning. The planar main sheet 240 can have a have hexagonal perimeter 244 or outline that is oblong with respect to the lateral pad centerline 242.

For example, the planar main sheet 240 can include a first and second triangular pad corners 246 that are oppositely located and oppositely directed with respect to the lateral pad centerline 242. For example, the first and second triangular pad corners 246 include two inclined edges that intersect with the lateral pad centerline 242 creating a triangular point at the opposite, oblong ends of the cleaning pad cover 106. To complete the oblong hexagonal shape, the hexagonal perimeter 244 can include first and second straight pad edges 248 that are parallel to the lateral pad centerline 242 and that extend between the first and second triangular pad corners 246.

To secure the cleaning pad cover 106 to the flat mop head 102, the first and second triangular pad corners 246 can each be configured as envelope-like pad pockets 250 defining regions for accommodating the correspondingly shaped first and second triangular pointed tips 212, 214 of the planar mop frame 210. The pad pockets 250 defined by the triangular pad corners 244, 246 can have a corresponding triangular outline and can be accessible by pocket edges 252 that are perpendicular to the lateral pad centerline 242 and that extend generally between the first and second straight pad edges 248.

To operatively cooperate with the split-frame design of the flat mop head 102, the lateral spacing between the parallel pocket edges 252 can be less than the longitudinal length of the frame plate 210 along the longitudinal frame axis 168 in the set position shown in FIG. 10. The first and second triangular pointed tips 212, 214 of the planar mop frame 210 are thus received into the opposed pad pockets 250 located at the corresponding first and second triangular pad corners 244, 246 when the planar frame plate 210 is fitted within the cleaning pad cover 106.

However, to facilitate insertion and fitting of the cleaning pad cover 106 to flat mop head 102, the distance between the pocket edges 250 along the lateral pad centerline 242 can be dimensionally larger with respect to the distance between the first and second triangular pointed tips 212, 214 when the frame plate 210 has been released and the lateral wings 220, 222 converge towards each other.

During installation, the planar main sheet 210 of the cleaning pad cover 106 is placed adjacent a floor or surface and the triangular pointed tips 212, 214 of the fame plate 210 are positioned and placed between opposed pocket edges 252. Pressing the frame plate 210 against the main sheet 210 causes the converged lateral wings 220, 222 to pivotally spread outward with respect to the lateral pad axis 242 and insert the triangular pointed tips 212, 214 into the pad pockets 250 as the frame plate 210 is moved into the planar set position. When the triangular pointed tips 212, 214 are inside the pad pockets 250, the cleaning pad cover 106 partially encompasses the frame plate 210 and is held firmly to the flat mop head 102.

In an embodiment, the pad pockets 250 can be configured differently to facilitate fitting the cleaning pad cover 106 to the frame plate 210. For example, the pocket edges 252 through which the pad pockets 250 are accessed can be positioned at different lateral locations with respect to the lateral pad centerline 242, with a first of the pocket edges located at the intersection of the first triangular pad corner 246 and the straight pad edges 248 and the second of the pocket edges positioned with the triangular outline laterally closer to the apex of the second triangular pad corner 246.

The pad pocket 250 associated with the second pocket edge 252 located closer to the apex of the pad corner 246 is smaller in dimension and can fit more closely with the corresponding triangular pointed tip 212, 214 of the frame plate 210 when inserted. The smaller pad pocket 250 may function to secure to cleaning pad cover 106. The larger pad pocket 250, in contrast, allows more free motion of the triangular pointed tip 212, 214 received therein, allowing for some relative motion between the cleaning pad cover 106 and the planar frame plate 210 when maneuvered in a wiping motion during cleaning.

To separate the cleaning pad cover 106 from the frame plate 210 after use, the split design of the frame plate 210 is released by moving the sliding latch 232 to disengage and release the catch 234. The lateral wings 220, 222 can pivotally collapsed toward each other with respect to the frame hinge axis 226 removing the triangular pointed tips 212, 214 from the pad pockets 250. The used cleaning pad cover 106 is thus released from the frame plate 210 and can be discarded without direct handling or physical contact by hand.

In an embodiment, to improve cleaning and reduce the likelihood of damaging surfaces, the outline of the hexagonal perimeter 244 can be dimensionally larger than the corresponding outline of the planar frame plate 210 when the first and second lateral wings 220, 222 are in the set position shown in FIG. 10. Accordingly, when the frame plate 210 is fitted within the cleaning pad cover 106, the hexagonal perimeter 244 spatially extends beyond and can surround the peripheral edges of the frame plate 210.

If the flat mop head 102 physically approaches or is moved into corner or the like, the extended hexagonal perimeter 244 of the cleaning pad cover 106 can be displaced or folded over the corresponding peripheral edges of the frame plate 210, thereby preventing direct physical contact with the harder material of the frame plate 210. This also ensures that the intersection surfaces being cleaned contact the softer fabric of the cleaning pad cover 106 and are exposed to any solutions or disinfectants contained therein.

In an embodiment, the main sheet 240 of cleaning pad cover 106 can have a multilayered construction of distinct physical plies having different properties or characteristics. For example, FIG. 12B shows an embodiment of the multilayered construction of the main sheet 240 comprising 3 different layers. The main sheet 240 can include an exterior microfiber layer 260 made of ultrathin microfibers of synthetic material such as polyester or polyamide. The exterior microfiber layer 260 can be characterized by its ability to absorb and retain small particle contaminants, including oils, and to wipe over surfaces without streaking or leaving residue. Microfiber textiles are also fairly soft and will not scratch surfaces and will not leave lint. The exterior microfiber layer 260 can be a nonwoven textile of split fibers.

To provide additional cushioning to the cleaning pad cover 106, the multilayered main sheet 240 can include an interior foam layer or foam pad 262. The foam pad 262 can be a compressible open or closed cell foam providing additional scratch resistance and adsorption for retaining a cleaning solution or disinfectant. The multilayered main sheet 240 can also include a backing layer 264 of polyester textile. The backing layer 264 may provide for added breathability of the cleaning pad cover 106.

In an embodiment, to further limit possible damage or scratching of surface, the exterior microfiber layer 250 can be folded and hemmed back over the foam pad 262 and the backing layer 264 of the main sheet 240. For example, at the hexagonal perimeter 244 of the cleaning pad cover 106, an extension of the exterior microfiber layer 260 can be folded back and wrapped over the peripheral edges of the foam pad 262 and backing layer 264 and secured by sewing to form a hem 266.

The hem 266 can be held in place by a sew line 268 that secures the folded flap of the exterior microfiber layer 260 to the foam pad 262 and the backing layer 264 of the main sheet 240. The sew line 268 can trace and run parallel with the hexagonal perimeter of the main sheet 240. The hem 266 ensures that when the cleaning pad cover 106 is moved into corners and the like, only the exterior microfiber layer 260 physically contacts the surfaces. The hem 266 may further reduce scratching and ensures the internal surfaces are adequately cleaned by the flat mop head 102.

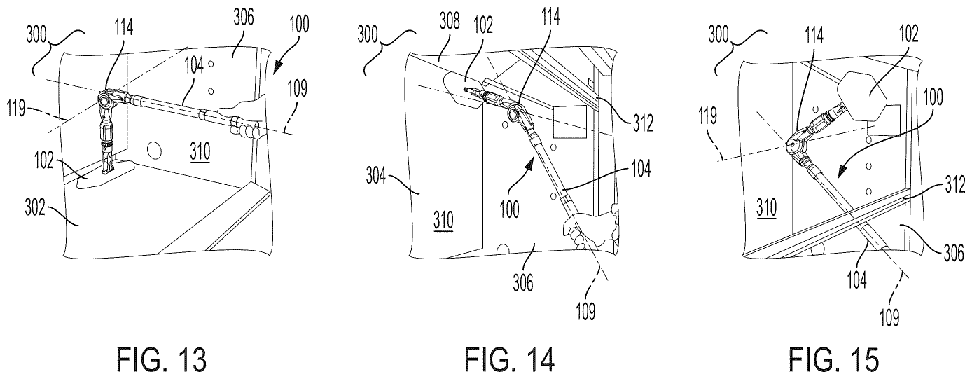

Referring to FIGS. 13-15, the improved accessibility provided by the articulating mop handle 104 of the cleaning device 100 to corners and crevasses of the controlled environment or RABS installation are depicted. For example, the controlled environment 300 can be characterized as having a plurality of intersecting planar surfaces that may be arranged orthogonally creating a series of right angle corners.

In an embodiment, the planar surfaces can include a floor 302, a back wall 304, a side wall 306, and a ceiling 308 that define an interior space 310 in which activities on hazardous or dangerous substances can be performed. During these activities, exposure to the interior space 310 can be reduced by a forwardly oriented sliding sash 312 parallel to the back wall 304. The sash 312 can be made of clear Plexiglas for visibility into the interior space 310.

During cleaning of the controlled environment 300, which may occur according to routine procedures in a laboratory setting, the articulating mop handle 104 allows the cleaning device 100 to be configured into the plurality of cleaning positions to access different internal planar surfaces. For example, FIG. 13 shows the cleaning device 100 with the articulating handle 104 configured into the right angled position 122 with the flat mop head 102 oriented at 90° with respect to the linear handle axis 109. The flat mop head 102 can be placed and pressed adjacently against the floor 202 and the articulating mop handle 104 moved back and forth in a wiping motion.

An advantage of the ability of the articulating mop handle 104 to be configured into the plurality of different cleaning positions 120-126 is that forces applied to the upper handle segment 110 are redirected by the articulating handle joint 114 to the desired orientation of the flat mop head 102. The cleaning device 100 can be easily manipulated by grasping the upper handle segment 110 in a comfortable or natural orientation while the articulating handle joint 114 geometrically orientates the flat mop head 102 to access difficult to reach areas within the interior space 310 of the controlled environment 300.

Referring to FIG. 14, in another aspect, the cleaning device 100 can be configured in the obtuse cleaning position 124 with the articulating mop handle 104 angled at 135° with respect to the linear handle axis 109. The obtuse cleaning position 124 allows the mop plane 108 of the flat mop head 102 to be placed parallel against the back wall 304 of the controlled environment 300. Adjacent and parallel abutment of the flat mop head 102 and the back wall 204 results in significant surface area coverage and cleaning.

If the height of the interior space 310 of the controlled environment 300 is relatively large, the telescoping upper handle segment 110 can be extended to reach the upper regions of the back wall 304. Furthermore, the cleaning device 100 can be turn around 180° with respect to the linear handle axis 109 so that the flat mop head is oriented toward the ceiling 308 for cleaning that surface.

The obtuse cleaning position 124 of the articulating mop handle 104 enables the flat mop head 104 to access corners and surfaces of the interior space 310 that would otherwise be difficult to reach. The obtuse cleaning position 124 also redirects the force applied through the articulating mop handle 104 from a direction along the linear handle axis 109 approximately 135° to a direction that applies the force to the flat mop head 102 in cleaning contact with an interior surface.

Referring to FIG. 15, in another aspect, the cleaning device 100 can be configured in the acute cleaning position 126 with the articulating mop handle 104 angled at 60° with respect to the linear handle axis 109. In the acute cleaning position 126, the articulating mop handle 104 can be inserted into the interior space 310 of the controlled environment 300 and the flat mop head 102 oriented rearward back to the partially lowered sash 312. A user can pull the articulating handle by applying for in the direction of the linear handle axis 109 such that that flat mop head 102 is placed adjacent to the sash 312 and maneuvered in an appropriate wiping action. The acute cleaning position 126 advantageously allows cleaning of the interior surface of the sash 312 from outside of the controlled environment 300. For example, an advantage of the acute cleaning position 126 is that the distal portion of the mop handle 104 is positioned outside of the interior space 310 of the controlled environment 300 and can be grasped by an operator without having to insert their hand into the interior space 310 when cleaning the sash 312.

It can be appreciated from FIGS. 13-15 that the combined assembly of the articulating mop handle 104, the telescoping upper handle segment 110, and the multiaxial mop coupling enables the flat mop head 102 of the cleaning device 100 to reach any and all of the interior surfaces of the restricted access controlled environment 300 from a position outside of the controlled environment. Avoiding insertion of body parts into the interior space 310 is beneficial if the controlled environment handles or is exposed to toxic or harmful substances. Accordingly, all the interior surfaces can be completely wiped down and disinfected by the cleaning pad cover 106, ensuring compliance with regulatory or standardized cleaning procedures.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A cleaning device for a restricted access controlled environment comprising:
an articulating mop handle elongated with respect to a linear handle axis and including an articulating handle joint having a locking mechanism for selectively locking the articulating mop handle in a plurality of cleaning positions with respect to the linear handle axis;
a hexagonally shaped flat mop head including a frame plate having a split-frame design and a microfiber cleaning pad cover releasably fitted to the mop frame; and
a mop coupling connecting the articulating mop handle to the flat mop head, the mop coupling configured to enable multiaxial movement of the flat mop head with respect to the linear handle axis.

2. The cleaning device of claim 1, wherein the frame plate includes a first triangular pointed tip and a second triangular pointed tip oppositely directed with respect to each other.

3. The cleaning device of claim 2, wherein the split-frame design of the frame plate includes a first lateral wing and a second lateral wing pivotally connected at a frame hinge.

4. The cleaning device of claim 3, wherein the mop frame including a spring-loaded sliding latch movably mounted on the first lateral wing and that can slide into engagement with a catch on the second lateral wing.

5. The cleaning device of claim 4, wherein the sliding latch, when engaged to the catch, secures the mop frame in a set position wherein the first lateral wing and the second lateral wing are co-planar.

6. The cleaning device of claim 4, wherein the cleaning pad cover includes a first pad pocket and a second pad pocket oppositely oriented with respect to each other to respectively receive the first triangular pointed tip and the second triangular pointed tip.

7. The cleaning device of claim 1, wherein the articulating handle joint include a depressible button to selectively lock and release the locking mechanism.

8. The cleaning device of claim 7, wherein the locking mechanism includes a plurality of detents circularly arranged and receivable in correspondingly circularly arranged plurality of locking apertures.

9. The cleaning device of claim 8, wherein the articulating mop handle include an upper handle segment and a lower handle segment connected by the articulating handle joint.

10. The cleaning device of claim 9, wherein the upper handle segment is configured as a telescoping handle segment including a telescopic shaft that is extendable and retractable with respect to a tubular sleeve along the linear handle axis.

11. The cleaning device of claim 10, wherein the telescoping handle segment includes a twist lock slip collar releasing and restraining sliding movement between the tubular sleeve and the telescopic shaft.

12. The cleaning device of claim 1, wherein the mop coupling includes a swivel pivot joint and frame pivot joint oriented orthogonally with respect to each other.

13. The cleaning device of claim 12, wherein the mop coupling includes a triangular frame link interconnecting the swivel pivot joint and the frame pivot joint.

14. The cleaning device of claim 13, wherein the mop coupling includes a connector collet clamped to the mop handle by a collect nut.

15. A cleaning device for a restricted access controlled environment comprising:
an articulated mop handle elongated with respect to a linear handle axis and comprising an upper handle segment and a lower handle segment joined at an articulating handle joint enabling the upper handle segment and the lower handle segment to angularly articulate with respect to a handle pivot axis that is orthogonal to the linear handle axis, the articulating handle joint include a locking mechanism for selectively locking the articulating mop handle in a plurality of angular cleaning positions with respect to the handle pivot axis a hexagonally shaped flat mop head having a frame plate defining a frame plane; and
a mop coupling connecting the articulating mop handle to the flat mop head, the mop coupling including:
a swivel pivot joint enabling the flat mop head to angularly articulate with respect to the articulating mop handle about a swivel axis that is orthogonal to the linear handle axis; and
a frame pivot joint enabling the flat mop head to angularly articulate with respect to the mop coupling about a longitudinal frame axis that is orthogonal to the swivel axis.

16. The cleaning device of claim 15, wherein the articulating handle joint include a depressible push button to selectively engage and disengage the locking mechanism.

17. The cleaning device of claim 16, wherein the locking mechanism includes a plurality of detent pins that are circularly arranged and receivable in a correspondingly circularly arranged plurality of locking apertures.

18. The cleaning device of claim 15, wherein the mop coupling includes a triangular frame link pivotally interconnecting the swivel pivot joint and the frame pivot joint.

19. The cleaning device of claim 15, wherein the frame plate is a split-frame design including a first lateral wing and a second lateral wing pivotally connected at a frame hinge.

20. The cleaning device of claim 19, wherein the first lateral wing includes a first triangular pointed tip and the second lateral wing includes a second pointed tip laterally oriented away with respect to each other.

21. The cleaning device of claim 20, wherein the frame plate include a spring-loaded sliding latch movably mounted on the first lateral wing and that can slide into engagement with a catch on the second lateral wing.

22. The cleaning device of claim 21, wherein the sliding latch, when engaged to the catch, secures the mop frame in a set position wherein the first lateral wing and the second lateral wing are co-planar with the mop plane.

23. The cleaning device of claim 15, wherein the segment is configured as a telescoping handle segment including a telescopic shaft that is extendable and retractable with respect to a tubular sleeve along the linear handle axis.

24. The cleaning device of claim 15, wherein the plurality of angular cleaning positions that can be selectively locked by the locking mechanism includes:
a right angled cleaning position wherein the upper handle segment and the lower handle segment are orthogonal to each other;
an obtuse cleaning position wherein upper handle segment and the lower handle segment are oriented at an obtuse angle to each other; and
an acute cleaning position wherein the upper handle segment and the lower handle segment are oriented at an acute angle to each other.
